(19) United States
(12) Patent Application Publication
(10) Pub. No.: US 2024/0196209 A1
(43) Pub. Date: Jun. 13, 2024

(54) METHOD AND APPARATUS FOR SELECTING A NETWORK ENTITY FOR USER EQUIPMENT CAMPING IN A WIRELESS COMMUNICATION SYSTEM

(71) Applicant: Samsung Electronics Co., Ltd., Suwon-si (KR)

(72) Inventors: Neha SHARMA, Bangalore (IN); Ramesh Chandra VUPPALA, Bangalore (IN); Anshuman NIGAM, Bangalore (IN); Dongmyoung KIM, Suwon-si (KR); Donghyun JE, Suwon-si (KR)

(21) Appl. No.: 18/532,436

(22) Filed: Dec. 7, 2023

(30) Foreign Application Priority Data
Dec. 9, 2022 (IN) 202241071072
Nov. 7, 2023 (IN) 2022 41071072

(51) Int. Cl. H04W 12/03; H04W 8/22; H04W 12/72; H04W 76/30

(52) U.S. Cl. CPC H04W 12/03; H04W 8/22; H04W 12/72; H04W 76/30

(57) ABSTRACT

The disclosure relates to a 5^{th} generation (5G) or 6^{th} generation (6G) communication system for supporting a higher data transmission rate. A method of UE for camping on a network entity is provided. The method includes receiving, by the UE, an information block from one of one or more network entities, determining, by the UE, if the indicated capability of the network entity or the corresponding security level are compliant with capability and security level requirement of the UE for camping, and camping by the UE, on the network entity when the indicated capability or the corresponding security level supported by the network entity is determined to be compliant with the capability and the security level requirement of the UE using the compliant type of cryptography technique.

### CROSS-REFERENCE TO RELATED APPLICATION(S)

This application is based on and claims priority under 35 U.S.C. § 119(a) of an Indian Provisional patent application number 202241071072, filed on Dec. 9, 2022, in the Indian Intellectual Property Office, and of an Indian Complete Specification patent application number 202241071072, filed on Nov. 7, 2023, in the Indian Intellectual Property Office, the disclosure of each of which is incorporated by reference herein in its entirety.

### BACKGROUND

### 1. Field

The disclosure relates to wireless communication networks. More particularly, the disclosure relates to a method and apparatus for selecting a network entity for user equipment camping based on cryptography techniques.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6^{th} generation (6G) mobile communication technologies (referred to as Beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random-access channel (RACH) for NR). There also has been ongoing standardization in system architecture/service regarding a 5G baseline architecture (e.g., service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide wireless communication systems and a method of User Equipment (UE) for camping on a network entity.

Additional aspects will be set forth in part in the description which follows and, in part, will be apparent from the description, or may be learned by practice of the presented embodiments.

In accordance with an aspect of the disclosure, a method is provided. The method includes receiving, by a UE, an information block from one of one or more network entities. The information block includes at least an indication of capability of the network entity to support at least one type of cryptography techniques and a corresponding security level. Further, the method includes determining, by the UE, if the indicated capability of the network entity and optionally, the corresponding security level are compliant with capability and security level requirement of the UE for camping. Thereafter, the method includes camping by the UE, on the network entity when the indicated capability and optionally, the corresponding security level supported by the network entity is determined to be compliant with the capability and the security level requirement of the UE using the compliant type of cryptography technique.

In accordance with another aspect of the disclosure, a User Equipment (UE) for camping on a network entity is provided. The UE includes a processor and memory communicatively coupled to the processor. The memory stores instructions, which, on execution, cause the processor to receive an information block from one of one or more network entities. The information block includes at least an indication of capability of the network entity to support at least one type of cryptography techniques and a corresponding security level. Further, the processor is configured to determine if the indicated capability of the network entity and optionally, the corresponding security level are compliant with capability and security level requirement of the UE for camping. Thereafter, the processor is further configured to camp on the network entity when the indicated capability and optionally, the corresponding security level supported by the network entity is determined to be compliant with the capability and the security level requirement of the UE using the compliant type of cryptography technique.

In accordance with another aspect of the disclosure, a method of a network entity for facilitating camping of the UE on the network entity is provided. The method includes transmitting, by the network entity, an information block comprising at least an indication of capability of the network entity to support at least one type of cryptography techniques and a corresponding security level. Further, the method includes receiving, by the network entity, a camping request from the UE, when the capability of the network entity and optionally, the corresponding security level are compliant with capability and security level requirement of the UE. Thereafter, the method includes facilitating, by the network entity, the UE to camp on the network entity using the compliant type of cryptography technique.

In accordance with another aspect of the disclosure, a network entity for facilitating camping of the UE on the network entity is provided. The network entity includes a processor and a memory. The memory is communicatively coupled to the processor. The memory stores instructions which on execution causes the processor is configured to transmit an information block comprising at least an indication of capability of the network entity to support at least one type of cryptography techniques and a corresponding security level. Further, the process is configured to receive a camping request from the UE, when the capability of the network entity and optionally, the corresponding security level are compliant with capability and security level requirement of the UE. Thereafter, the processor is configured to camp on the network entity using the compliant type of cryptography technique.

In accordance with another aspect of the disclosure, a method of User Equipment (UE) for camping on a network entity is provided. The method includes receiving, by the UE, an information block from a plurality of network entities. The information block includes at least an indication of capability of the corresponding network entity to support at least one type of cryptography technique and a list of priority parameters related to each cryptographic profile supported by the corresponding network entity. Furthermore, the method includes determining, by the UE, if the indicated capability of each of the plurality of network entities and the list of priority parameters related to at least one cryptographic profile supported by each of the plurality of network entities are compliant with at least one of capability and priority requirements of the UE for camping. Furthermore, the method includes selecting, by the UE, an optimal network entity determined to be completely compliant with the capability and the priority requirements of the UE, from the plurality of network entities whose indicated capability and the list of priority parameters related to at least one cryptographic profile supported by the network entity are determined to be compliant with at least one of the capability and the priority requirements of the UE. Thereafter, the method includes camping, by the UE, on the optimal network entity, using the compliant type of cryptography technique.

In accordance with another aspect of the disclosure, a User Equipment (UE) for camping on a network entity is provided. The UE includes a processor and memory communicatively coupled to the processor. The memory stores instructions, which, on execution, cause the processor to receive an information block from a plurality of network entities. The information block includes at least an indication of capability of the corresponding network entity to support at least one type of cryptography technique and a list of priority parameters related to each cryptographic profile supported by the corresponding network entity. Furthermore, the processor is configured to determine if the indicated capability of each of the plurality of network entities and the list of priority parameters related to at least one cryptographic profile supported by each of the plurality of network entities are compliant with at least one of capability and priority requirements of the UE for camping. Furthermore, the processor is configured to select an optimal network entity determined to be completely compliant with the capability and the priority requirements of the UE, from the plurality of network entities whose indicated capability and the list of priority parameters related to at least one cryptographic profile supported by the network entity are determined to be compliant with at least one of the capability and the priority requirements of the UE. Thereafter, the processor is configured to camp on the optimal network entity using the compliant type of cryptography technique.

In accordance with another aspect of the disclosure, a method for network entity for facilitating camping of the UE on the network entity is provided. The method includes transmitting, by a plurality of network entities, an information block comprising at least an indication of capability of a corresponding network entity to support at least one type of cryptography techniques and a list of priority parameters related to each supported cryptographic profile supported by each of the plurality of network entities. Further, the method includes receiving, by an optimal network entity from the plurality of network entities, a camping request from the UE. The indicated capability and the list of priority parameters related to at least one cryptographic profile supported by the optimal network entity are determined to be completely compliant with the capability and the priority requirements of the UE. Thereafter, the method includes facilitating, by the optimal network entity, the UE 104 to camp on the optimal network entity, using the compliant type of cryptography technique.

In accordance with another aspect of the disclosure, a network entity for facilitating camping of the UE on the network entity is provided. The network entity includes a processor and a memory. The memory is communicatively coupled to the processor. The memory stores instructions which on execution causes the processor is configured to transmit an information block comprising at least an indication of capability of a corresponding network entity to support at least one type of cryptography techniques and a list of priority parameters related to each cryptographic profile supported by each of the plurality of network entities. Furthermore, the processor is configured to receive a camping request from the UE to camp on the optimal network entity. The indicated capability and the list of priority parameters related to at least one cryptographic profile supported by the optimal network entity are determined to be completely compliant with the capability and the priority requirements of the UE. Thereafter, the processor is configured to facilitate the UE to camp on the optimal network entity using the compliant type of cryptography technique.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a schematic representation depicting an environment for camping on one or more network entities by a User Equipment (UE), according to an embodiment of the disclosure;

FIG. 2A illustrates a detailed block diagram of a User Equipment (UE) for camping on one or more network entities, according to an embodiment of the disclosure;

FIG. 2B depicts a detailed block diagram of a network entity for facilitating camping of a User Equipment (UE) on one or more network entities, according to an embodiment of the disclosure;

FIG. 2C depicts an embodiment of a network entity facilitating camping of a User Equipment (UE) on a network entity, according to an embodiment of the disclosure;

FIG. 2D depicts an embodiment of a network entity facilitating camping of a User Equipment (UE) on a network entity, according to an embodiment of the disclosure;

FIG. 3A illustrates a flowchart illustrating a method of a User Equipment (UE) camping on a network entity, according to an embodiment of the disclosure;

FIG. 3B illustrates a flowchart illustrating a method of a User Equipment (UE) camping on a network entity, according to an embodiment of the disclosure;

FIG. 3C illustrates a flowchart illustrating a method of a network entity facilitating camping of a User Equipment (UE) on one or more network entities, according to an embodiment of the disclosure;

FIG. 3D illustrates a flowchart illustrating a method of a User Equipment (UE) for camping on one of one or more network entities, according to an embodiment of the disclosure;

FIG. 3E illustrates a flowchart illustrating a method of a network entity for facilitating camping of a User Equipment (UE) on a network entity, according to an embodiment of the disclosure;

FIG. 4 illustrates a block diagram of a User Equipment (UE) according to an embodiment of the disclosure;

FIG. 5 illustrates a block diagram of a terminal (or a user equipment (UE), according to an embodiment of the disclosure; and

FIG. 6 illustrates a block diagram of a network entity, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the disclosure. The following description is, therefore, not to be taken in a limiting sense.

During recent years, various cellular networks such as a Second generation (2G) network, a Third Generation (3G) network, a Fourth Generation (4G) network have been developed to provide various services such as voice services, data services, high-speed data services and the like, for providing better applications and cellular network services to users. However, currently, the 4G networks lack resources that are required to meet ever-growing demand of high-speed data services.

Further, in the existing technology, various cell selection procedures may be performed to camp on the cellular networks (alternatively referred as network entity) to determine an appropriate carrier for camping. Conventionally, a User Equipment (UE) may camp on the cellular network using two different types of cell selection procedures.

In a first type of cell selection procedure, the UE may scan all Radio Frequency (RF) channels in New Radio (NR) bands according to capabilities of the UE to find a suitable cell. In case no suitable cell is found during the first type of cell selection procedure, the UE may perform a second type of cell selection procedure by leveraging stored information. The stored information may include cell parameters from a measurement control information element received previously from detected cells. In the second type of cell selection procedure, the UE may find the suitable cell from the stored information based on frequencies and optionally, based on information related to the cell parameters from the stored information. However, aforementioned type of cell selection procedures may be time consuming as these cell selection procedures may require many reiterations until the UE determines the suitable cell.

Further, in the existing art, various cryptography algorithms are utilized to protect data associated with the cellular network and devices. Further, because of increase in demand and use of quantum computers, and since, these quantum computers have an ability to decrypt the cryptography algorithms easily, then this ability of the quantum computers may lead to cryptography security related issues. In order to solve these cryptography security related issues, Post Quantum Cryptography (PQC) techniques may be utilized. Further, because of use of the PQC techniques in the cellular network for encryption, the quantum computers may not be able to decrypt an algorithm associated with the PQC techniques and may easily protect the data.

Further, in the existing art, for performing cell selection procedures, in some instances, due to ever growing demands of quantum computers, the 5G networks and above may support just the PQC techniques to encrypt the data more securely. Further, due to the presence and utilization of other devices apart from the quantum computers, the UE or the cellular networks may also support legacy techniques to encrypt the data. The legacy techniques are techniques such as symmetric cryptography technique, asymmetric cryptography technique and the like. Considering the aforementioned scenario, if the UE supports the legacy technique only and the network supports the PQC technique only (or vice versa), then a Subscriber Permanent Identifier (SUPI) is encrypted using the legacy algorithm and generates a Subscription Concealed Identifier (SUCI) at UE. Thereafter, the generated SUCI is shared to cellular network in the form of a registration request message for camping on the cellular network. Upon receiving the registration request message, as the cellular network does not support the PQC technique and only the legacy technique, the cellular network is not able to decrypt the SUCI received from UE and hence, rejects the registration request for camping. This causes failure in authentication procedure and the UE may not be able to perform a successful registration procedure for camping on the cellular network. This may further cause delay in camping and registration procedure as the UE will have to reiterate performing the cell selection procedure.

Therefore, there is a need for an improvised method of User Equipment (UE) for camping on a network entity.

The information disclosed in this background of the disclosure section is only for enhancement of understanding of the general background of the disclosure and should not be taken as an acknowledgement or any form of suggestion that this information forms the prior art already known to a person skilled in the art.

In a conventional approach, demands for quantum computers is ever growing and these quantum computers have an ability to decrypt cryptography algorithms easily, leading to cryptography security related issues. In order to solve these cryptography security related issues, cellular networks such as 5G networks, 6G networks and so on may support Post Quantum Cryptography (PQC) techniques to encrypt data more securely. Further, in some other instances, the cellular networks may also support legacy techniques to encrypt the data. Considering the aforementioned scenario, if a UE supports the legacy technique and the cellular network supports the PQC technique, then, this may lead to a condition of non-compliance of capability of the UE with the cellular network leading to failure in authentication procedure. Further, because of the aforementioned scenario, there may be delay in camping and registration procedure as the UE may have to reiterate performing the cell selection procedure.

In order to solve the aforementioned problem, the disclosure discloses a method of User Equipment (UE) for camping on a network entity. In other words, the disclosure discloses a method and apparatus for selecting a network entity for user equipment camping based on cryptography techniques. The method comprises receiving, by the UE, an information block from one of the one or more network entities. The information block includes an indication of capability of the one of the one or more network entities to support a type of cryptography technique. Based on the indication, the method comprises determining, by the UE, if the indicated capability of the one of the one or more network entities and optionally, the corresponding security level are compliant with capability and security level requirement of the UE for camping. If the capability is met then a camping request may be sent to the one of the one or more network entities to facilitate camping of the UE. Thereafter, the method comprises camping by the UE, on the network entity using the compliant type of cryptography technique upon successfully facilitating of camping by the one of the one or more network entities. Hence, the disclosure may be configured to provide an optimized approach for the UE to camp on the one or more network entities resulting in no delay in camping and registration process.

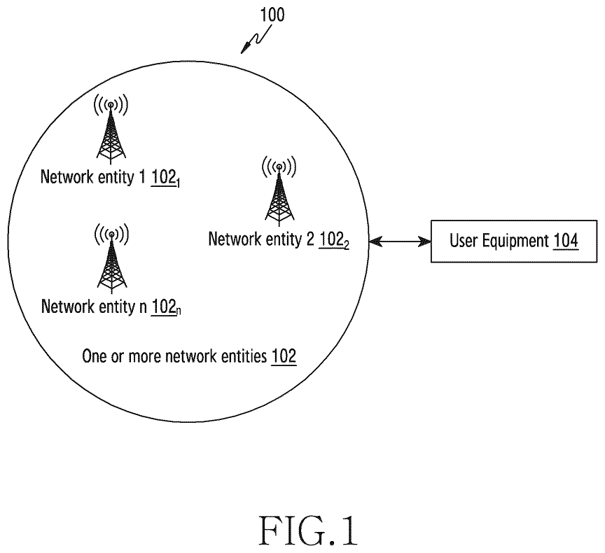

FIG. 1 illustrates a schematic representation depicting an environment for camping on one or more network entities by a User Equipment (UE), according to an embodiment of the disclosure.

Referring to FIG. 1, an environment 100 includes on one or more network entities 102, such as network entity 1 102₁, network entity 2 102₂, network entity 3 102₃, to network entity N 102N, (collectively referred as one or more network entities 102) and the UE 104.

The one or more network entities 102 may transmit an information block to the UE 104. In some embodiments, the information block may be transmitted via a broadcast signal to the UE 104. In some other embodiments, the information block may be transmitted to the UE 104 in the form of a capability request. The capability request is a type of request the UE 104 sends to obtain the type of the cryptography technique supported by the one of the one or more network entities 102. The information block is a type of block indicating the capability of a type of cryptography technique and a corresponding security level supported by the one of the one or more network entities 102. The information block may be a System Information Block (SIB) i.e., SIB₁, SIB₂ . . . SIBn and the like. Alternatively, in some other embodiments, the information block may be a Master Information Block (MIB). Furthermore, in some other embodiments, the information block may be received via a Radio Resource Configuration (RRC) release message or an RRC rejection message. The SIB, the MIB, the RRC release message or the RRC rejection message may be utilized to transmit the indication of the capability of the one of the one or more network entities 102 to the UE 104. In some instances, the type of cryptography techniques supported by the one of the one or more network entities 102 may include a Post Quantum Cryptography (PQC) technique. In some other instances, the type of cryptography techniques supported by the one of the one or more network entities 102 may include a legacy technique including at least one of, but not limited to, a symmetric cryptography technique or an asymmetric cryptography technique. In the context of the disclosure, the one or more network entities 102 may be an entity that enables the UE 104 to connect through a communication network and communicate with the UEs 104 for camping. In other words, the one or more network entities 102 may be transceivers in a communication network, which act as a main communication point for camping of the UE 104. As an example, the one or more network entities may be a cell, a base station, a radio unit, an access point and the like.

Given below is a first embodiment depicting camping of the UE 104 on the one of the one or more network entities 102.

Upon receiving the information block from the one of the one or more network entities 102, based on the type of cryptography technique, in some embodiments, the UE 104 may determine if the indication of the capability of the type of cryptography technique supported by the one of the one or more network entities 102 and optionally, the security level are compliant with the capability of the type of cryptography technique and optionally, the security level supported by the UE 104.

Upon determining the indication of the capability of the type of cryptography technique supported by the one of the one or more network entities 102 and optionally, the corresponding security level are compliant with the capability of the type of cryptography technique and the security level supported by the UE 104, in some embodiments, the UE 104 may be configured to send a camping request to camp on the one of the one or more network entities 102. For example, in some instances, if the capability of a UE is to support PQC technique up to security level three and if the capability of one of the one or more network entities is to support PQC technique up to security level four, then in such instances even if the compliance with respect to security is not met and only the compliance with respect to capability of supporting the cryptography technique is met, the UE camps on the one of the one or more network entities, as the compliance with respect to the security level is optional. The camping request may include an identifier of the UE 104 encoded using the compliant type of cryptography technique. Thereafter, the one of the one or more network entities 102 may facilitate the UE 104 to camp on the one of the one or more network entities 102 by decoding the identifier of the UE 104 using the compliant type of cryptography technique and may facilitate the UE 104 to camp on the one of the one or more network entities 102 upon decoding the identifier successfully. Thereafter, the UE 104 may camp on the one of the one or more network entities 102 and informs the upper layers to use the compliant type of cryptographic technique for encoding and decoding of the identifier.

For example, if the UE determines that the PQC technique is the complaint type of cryptography technique, then, Subscriber Permanent Identifier (SUPI) which is one of the identifiers is encoded using the PQC technique and generates a Subscription Concealed Identifier (SUCI). The camping request includes this encrypted SUCI and a request for the UE to camp on the one of the one or more network entities. Now, since the compliance between the UE and the network entity are met, the one of the one or more network entities is able to decode the SUCI and the one of the one or more network entities facilitates the UE to camp using the PQC technique and informs the upper layers to use the PQC technique. In some embodiments, encoding and decoding the identifier may also be referred as encrypting and decrypting.

In some embodiments, if the capability of the one of the one or more network entities 102 and optionally, the corresponding security level is determined to be not compliant with capability and the security level requirement of the UE 04, the UE 104 may send a capability request to one of the rest of the one or more network entities 102 and may receive an information block from the one of rest of the one or more network entities 102. The capability request is a type of request that the UE 104 may send to obtain information related to the type of the cryptography technique supported by the one or more network entities 102. Further, the UE 104 may determine if the indicated capability of one of rest of the one or more network entities 102 and optionally, the corresponding security level are compliant with capability and security level requirement of the UE 104 for camping. Thereafter, the UE 104 may camp if the capability of the one of rest of the one or more network entities 102 and optionally, the corresponding security level supported by the one of rest of the one or more network entities 102 is determined to be compliant with the capability and the security level requirement of the UE 104. Thereafter, if the capability of one of rest of the one or more network entities 102 and optionally, the security level supported is determined to be not compliant with the capability and the security level requirement of the UE 104, then, the UE 104 may be configured to reiterate the steps of requesting, receiving, determining, and camping with other network entities until the UE 104 finds a compliant type of network entity for camping.

For example, upon performing the process of receiving the information block from a network entity A, the UE determines that the capability of the network entity A is not compliant with the capability of the UE, then the UE is configured to reiterate the steps of receiving and determining with network entity D, network entity G, network entity J and the like one after the another sequentially, until the UE determines at least one of the rest of the one or more network entities is capable of supporting the capability and the security level requirement of the UE, for camping.

Further, given below is a second embodiment that discloses camping on one of the one or more network entities 102 by a UE 104 based on one or more priority requirements of the UE 104.

In some embodiments, the UE 104 may be configured to receive an information block from plurality of network entities. The information block may include, but not limited to, an indication that indicates that the corresponding network entity 102 supports at least one type of network entity and a list of priority parameters. The list of priority parameters may be related to each cryptography technique supported by the corresponding network entity 102. Furthermore, the UE 104 may be configured to determine if the capability of each of the plurality of network entities and the list of priority parameters indicated are compliant with at least one capability and priority requirements of the UE 104. The list of priority parameters may be related to prioritizing at least one of a type of cryptography technique, a cryptography profile, a corresponding key length and corresponding security level. The priority requirements of the UE 104 may be the type of requirements related to prioritizing one of the plurality of network entities 102 that supports one type of cryptography technique, the cryptography profile and the corresponding key length. Furthermore, when the indicated capability of the UE 104 and the capability of plurality of network entities 102 are compliant, then among the plurality of network entities 102, the UE 104 may select an optimal network entity. The optimal network entity is a type of network entity that may be determined to be completely compliant with capability and priority requirements of the UE 104 from the plurality of network entities 102. In context of the disclosure, the term “completely compliant” may be subjective in nature. For instance, consider the UE has a priority requirement of supporting a specific PQC technique and a specific security level. In such instances, since, both specific PQC technique and the specific security level are mandatory priority requirements, the term “completely compliant” may mean complying with both specific PQC technique and specific security level. In another instance, consider the UE has a priority requirement of supporting a specific PQC technique and optionally a specific security level. In such instances, since, only specific PQC technique is a mandatory priority requirement, the term “completely compliant” may mean complying with the specific PQC technique. However, if there is a network entity that complies with both the specific PQC technique and the specific security level, such network entities may be preferred than the network entity that complies with only the specific PQC technique. Thereafter, the UE 104 may be configured to send a camping request to the optimal network entity for camping.

For example, consider the UE has a priority requirement “1” that includes supporting PQC technique up to security level three. Now, in the aforementioned scenario UE determines network entities B and C are meeting the priority requirement “1” as they are capable of supporting the PQC technique. This aforementioned scenario provides an inference that network entities B and C are the plurality of the network entities that meet the priority requirements of the UE. Thereafter, consider the aforementioned scenario where the network entities B and C are the plurality of network entities that are compliant with the priority requirements of the UE. Now, for determining the optimal network entity among the plurality of network entities, the UE determines that the network entity C is capable of supporting the PQC technique up to security level one and the network entity B is capable of supporting the PQC technique up to the security level three. This provides an inference that the network entity B that complies with both PQC technique and security level according to the priority requirements of the UE is more desired compared to network entity C which supports the security level different from the security level mentioned in the priority requirements of the UE. Therefore, in the aforementioned scenario, though both network entities B and C were compliant with the PQC technique, only network entity B was compliant with both the PQC technique and the security level. Therefore, in the aforementioned scenario network entity B is determined to be the optimal network entity among the plurality of network entities that meet the priority requirements of the UE. Upon selecting the optimal network entity, the UE sends a camping request to camp on the optimal network entity. The camping request may include an identifier of the UE encoded using the compliant type of cryptography technique. The compliant type of cryptography technique provides an inference that the requirement of the UE is same as that of the one or more network entities for camping. Thereafter, the optimal network entity may facilitate the UE to camp on the candidate network entity by decoding the identifier of the UE using the compliant type of cryptography technique and may facilitate the UE to camp on the optimal network entity upon decoding the identifier successfully. Thereafter, the UE may camp on the optimal network entity and informs the upper layers to use the compliant type of cryptographic technique for encoding and decoding of the identifier using the compliant type of cryptography technique.

In some other embodiments, the UE 104 may be configured to camp on any one of the plurality of network entities 102 using the legacy technique when the indicated capability and priority requirements of the UE 104 are not compliant with the capability and list of priority parameters related to at least one of the cryptographic profile by each of the plurality of network entities 102.

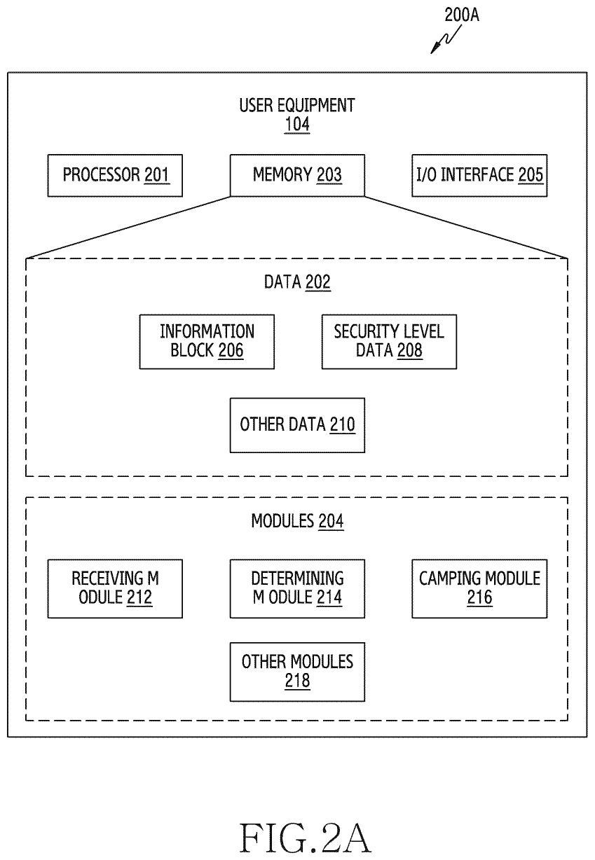

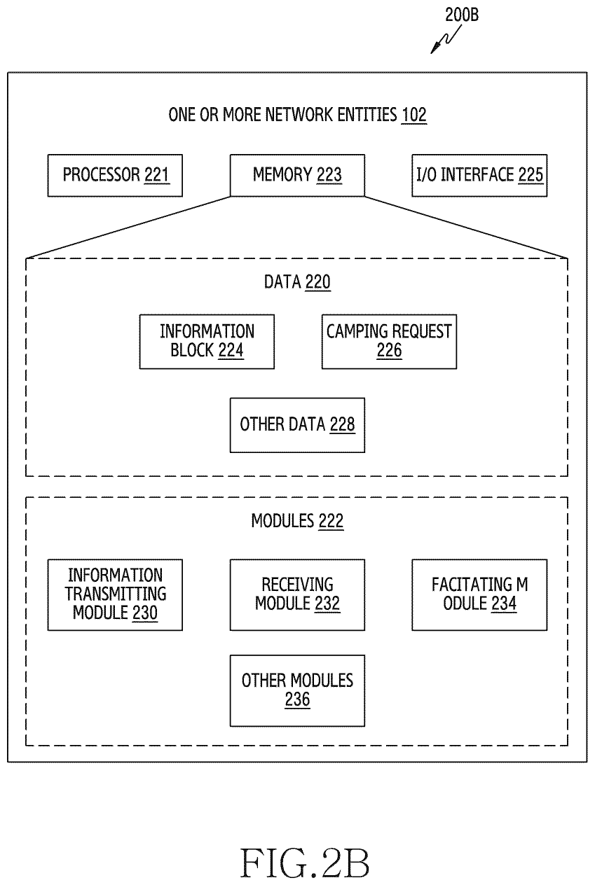

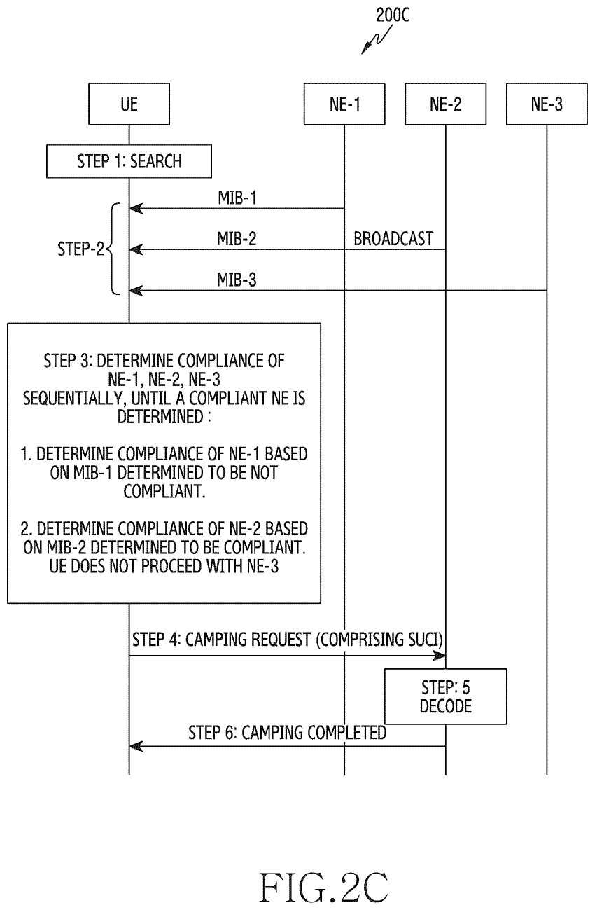

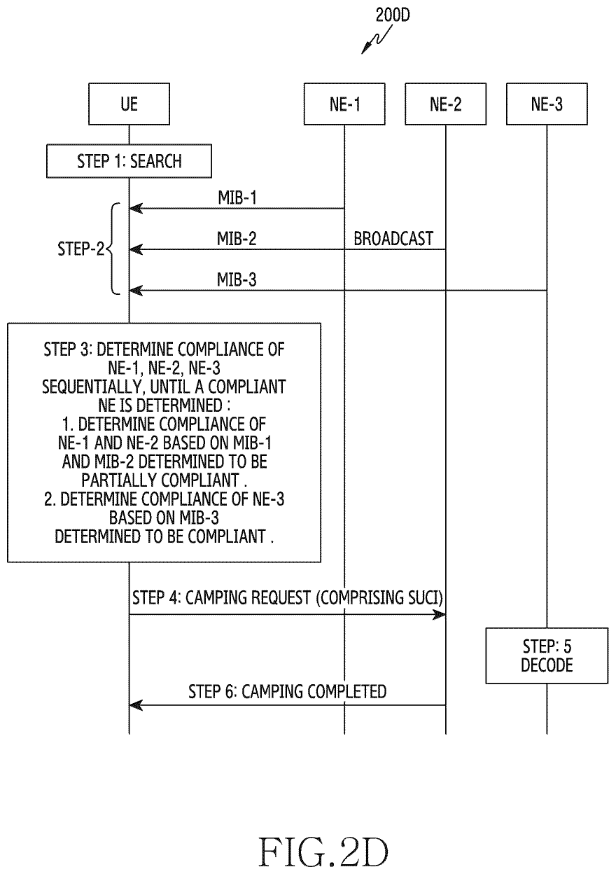

FIG. 2A illustrates a detailed block diagram of a User Equipment (UE) for camping on one or more network entities, according to an embodiment of the disclosure.

Referring to FIG. 2A, in a block diagram 200A, the UE 104 may include a processor 201, an I/O interface 205 and a memory 203. The I/O interface 205 may be configured for receiving and transmitting an input signal or/and an output signal related to one or more operations of the UE 104. The memory 203 may be communicatively coupled to the processor 201 and one or more modules 204. The processor 201 may be configured to perform one or more functions of the UE 104 using data 202 and the one or more modules 204.

In an embodiment, the data 202 stored in the memory 203 may include without limitation an information block 206, security level data 208 and other data 210. In some implementations, the data 202 may be stored within the memory 203 in the form of various data structures. Additionally, the data 202 may be organized using data models. The other data 210 may include various temporary data and files generated by the different components of the UE 104.

In some embodiments, the information block 206 may be a type of information block which comprises an indication of capability of the one or more network entities 102 to support at least one type of cryptography technique. The type of cryptography technique may include, but not limited to, a PQC technique, a symmetric cryptography technique or an asymmetric cryptography technique. The capability of the network entity 102 to support at least one type of cryptography technique may be indicated in the form of a list of cryptography profiles supported by the network entity 102. For ease of reference in the disclosure, the one or more network entities 102 may also be referred as network entity. Alternatively, capability of the network entity 102 to support at least one type of cryptography techniques may be indicated via a list of frequencies related to each cryptography profile supported by the one or more network entities 102. For instance, list of frequencies may be a priority given to a type of cryptography technique. For example, a priority one is given to PQC 2 technique, a priority two is given to a PQC 3 technique. Based on the aforementioned example, an inference may be obtained that the UE 104 may camp on the one or more network entities 102 based on highest priority that is the priority one among the list of frequencies. The information block 206 may be a System Information Block (SIB) i.e., SIB₁, SIB₂ . . . SIBₙ and the like. Alternatively, in some other embodiments, the information block 206 may be a Master Information Block (MIB). Furthermore, in some other embodiments, the information block 206 may be received via a Radio Resource Configuration (RRC) release message or an RRC rejection message. In some embodiments, the information block 206 may be received from the one or more network entities 102 in response to a capability request from the UE 104. The capability request is a type of request that the UE 104 may send to obtain the indication of the type of the cryptography technique supported by the one or more network entities 102. In some other embodiments, the information block 206 may be received from the one or more network entities 102 in the form of broadcast signals. For example, the one or more network entities 102 broadcasts to the UE 104 that the one or more network entities 102 is capable of supporting only the PQC technique from frequency range of three and up to a security level of four in the form of MIB. For example, the one or more network entities 102 broadcasts to the UE 104 that the one or more network entities 102 is capable of supporting only legacy techniques such as asymmetric cryptography techniques via a RRC release message.

In some embodiments, the security level data 208 may include different types of security levels supported by the one or more network entities 102. The security level may include level of security provided to the one of the one or more network entities 102 for securing the one of the one or more network entities 102 and data. As an example, the security level may be security level one, security level two and the like as per requirement. In the context of the disclosure, the security level for the one or more network entities 102 may be based on preference of a network operator. For example, in an instance, the network operator has the preference that the network entity C is configured to be protected up to security level three and network entity D is configured to be protected up to security level two. The aforementioned instance may provide an inference that the network entity C is configured to receive a higher level of security as compared to the network entity D.

In some embodiments, the data 202 may be processed by the one or more modules 204 of the UE 104. In an implementation, the one or more modules 204 may include, without limiting to, a receiving module 212, a determining module 214, a camping module 216 and other modules 218. In an embodiment, the other modules 218 may be used to perform various miscellaneous functionalities of the UE 104. It will be appreciated that such one or more modules 204 may be represented as a single module or a combination of different modules.

In an embodiment, the receiving module 212 may be configured to receive the information block 206 from one of the one or more network entities 102. In the embodiment, the determining module 214 may be configured to determine compliance of capability of the one or more network entities 102 with the capability of the UE 104, sequentially. In the embodiment, the camping module 216 may be configured to enable the UE 104 to camp on the one of the one or more network entities 102. The modules of the UE 104 are explained in detail from the perspective of the first and second embodiments, in the upcoming sections of the disclosure.

FIG. 2B illustrates a detailed block diagram of a network entity for facilitating camping of a User Equipment (UE) on one or more network entities, according to an embodiment of the disclosure.

Referring to FIG. 2B, a detailed block diagram 200B, the network entity 102 may include a processor 221, an I/O interface 225 and a memory 223. The I/O interface 225 may be configured for receiving and transmitting an input signal or/and an output signal related to one or more operations of the network entity 102. The memory 223 may be communicatively coupled to the processor 221 and one or more modules 222. The processor 221 may be configured to perform one or more functions of the network entity 102 for performing multiple-turn actions using data 220 and the one or more modules 222.

In an embodiment, the data 220 stored in the memory 223 may include without limitation an information block 224, a camping request 226 and other data 228. In some implementations, the data 220 may be stored within the memory 223 in the form of various data structures. Additionally, the data 220 may be organized using data models. The other data 228 may include various temporary data and files generated by the different components of the network entity 102.

The information block 224 may be a type of block which comprises an indication of capability of one of the one or more network entities 102 to support at least one type of cryptography technique.

The camping request 226 may be a type of request which includes a request to camp on the selected one of the one or more network entities 102.

In some embodiments, the data 220 may be processed by the one or more modules 222 of the network entity 102. In an implementation, the one or more modules 222 may include, without limiting to an information transmitting module 230, a receiving module 232, a facilitating module 234 and other modules 236. In an embodiment, the other modules 236 may be used to perform various miscellaneous functionalities of the network entity 102. It will be appreciated that such one or more modules 222 may be represented as a single module or a combination of different modules.

In an embodiment, the information transmitting module 230 may be configured to transmit the information block 224 to the UE 104. In the embodiment, the facilitating module 234 may be configured to facilitate camping on the network entity 102 using the compliant type of cryptography technique. Further, the facilitating module 234 may be configured to decode the identifier of the UE 104 using the compliant type of cryptography technique. Thereafter, upon decoding the identifier successfully, the facilitating module 234 may be configured to facilitate the UE 104 to camp on the network entity 102. The modules of the network entity 102 are explained in detail from the perspective of the first and second embodiments, in the upcoming sections of the disclosure.

Henceforth, the process of facilitating camping of the UE 104 on the network entity 102 is explained with the help of one or more examples 200C for better understanding of the disclosure as disclosed in FIG. 2C.

FIG. 2C illustrates a detailed block diagram of a network entity for facilitating camping of a User Equipment (UE) on one or more network entities, according to an embodiment of the disclosure.

However, the one or more examples should not be considered as limitation of the disclosure.

Consider a scenario 1 illustrating the first embodiment such that the UE is supporting PQC technique up to a security level four between frequency range of two-four.

Referring to FIG. 2C, at step 1, the UE searches for one or more network entities that are capable of supporting the PQC technique up to a security level four between frequency range of two-four. At step 2, the receiving module 212 receives an information block MIB from NE-1, NE-2 and NE-3 via broadcasting.
The information block for NE-1 includes an indication that the NE-1 is capable of supporting a legacy technique up to security level one at a frequency range of one.
The information block for the NE-2 includes an indication that the NE-2 is capable of supporting the PQC technique up to a security level three between at a frequency range of three.
The information block for the NE-3 includes an indication that the NE-3 is capable of supporting the legacy technique up to a security level two at a frequency range of three.

At step 3, the determining module 214 determines that the (1) capability of the NE-1 is not compliant with the capability of the UE as the UE is capable of supporting the PQC technique and the NE-1 is capable of supporting the legacy technique. Further, the determining module 214 determines that the (2) capability of the NE-2 is compliant with the capability of the UE as both the UE and the NE-2 are capable of supporting the PQC technique up to security level of three at the frequency range of three. Since, the determining module 214 determines that the capability of NE-2 is compliant with the capability of the UE, then the UE does not proceed with NE-3.

Prior to performing the step four, the UE encodes a SUPI using the compliant type of the cryptography technique (i.e., PQC technique) and generates a SUCI accordingly. Thereafter, at step four the receiving module 232 of the NE-2 receives a camping request from the UE. The camping request includes this encrypted SUCI along with the request to camp on the NE-2. Since the compliance between the UE and the NE-2 are met, at step five, the facilitating module 234 decodes the SUCI and the facilitating module 234 facilitates the UE to camp on the NE-2 using the PQC technique and informs the upper layers to utilize the same PQC technique. At step 5, the UE camps on the NE-2.

However, in the above scenario-1 if the UE had determined that the capability of both NE-1 and NE-2 is not compliant with the capability of the UE, then the determining module 214 and the camping module 216 proceeds to reiterate the steps of determining and camping with rest of the one or more network entities. If the capability fails to match with the rest of the one or more network entities as well, then the UE may camp on any of the network entities using the legacy technique.

Henceforth, the process of facilitating camping of the UE 104 on the network entity 102 is explained with the help of one or more examples 200D for better understanding of the disclosure as disclosed in FIG. 2D.

FIG. 2D illustrates an example of a network entity facilitating camping of a User Equipment (UE) on a network entity, according to an embodiment of the disclosure. However, the one or more examples should not be considered as limitation of the disclosure.

Referring to FIG. 2D, consider a scenario 2 illustrating the second embodiment such that the UE is capable of supporting the cryptography techniques based on a list of priority parameters provided by a network operator.
The first priority includes capability of supporting a PQC 1 technique at a security level two at frequency range of three.
The second priority includes capability of supporting a PQC 2 technique up to a security level three between frequency range of four.
The third priority includes capability of supporting a PQC technique up to a security level four between frequency range of two and three.

In this scenario, consider the desired priority requirement is the first priority. At step 1, the UE is configured to search one or more network entities that meet the first priority requirement. At step 1, the receiving module 212 of the UE receives an information block MIB from a NE-1, NE-2, and NE-3 via broadcasting.
The information block of the NE-1 comprises the NE-1 is capable of supporting a PQC-1 technique up to a security level zero at frequency range of three.
The information block of the NE-2 comprises NE-2 is capable of supporting a PQC-1 technique up to a security level five at frequency range of one.
The information block of the NE-3 comprises NE-3 is capable of supporting a PQC-1 technique up to a security level two at frequency range of three.

Now, the determining module 214 performs the steps of determination with each NE-1, NE-2, and NE-3, sequentially at step 2. At the step 2, the determining module 214 determines the capability of the NE-1 and NE-2 are partially compliant with the capability of the UE.
The partial compliance of the UE and the NE-1 provides an inference that that compliance between the UE and the NE-1 has been partially met as the compliance with respect to supporting the cryptography technique is met whereas the compliance with respect to frequency range is not met as per priority requirement one.
The partial compliance of the UE and the NE-2 provides an inference that compliance between the UE and the NE-2 has been partially met as the compliance with respect to supporting the cryptography technique is met whereas the compliance with respect to security level is not met and frequency range is not met.

Further, the determining module 214 determines that the capability of the NE-3 is compliant with the capability of the UE because both the UE and the NE-3 are capable of supporting the PQC 1 technique at a security level two and a frequency range of three. Prior to performing the step four, the UE encodes a SUPI using the compliant type of the cryptography technique (i.e., PQC 1 technique) and generates a SUCI accordingly. Thereafter, at step four the receiving module 232 of the network entity B receives a camping request from the UE. The camping request includes this encrypted SUCI along with the request to camp on the NE-3. Since the compliance between the UE and the NE-3 is met, at step five, the facilitating module 234 decodes the SUCI and the facilitating module 234 facilitates the UE to camp on the network entity B using the PQC 1 technique and informs the upper layers to utilize the same PQC technique. At step 5, the UE camps on the NE-3.

However, if the UE determines that the capability of the NE-1, NE-2 and NE-3 is not compliant with the capability of the UE, then the UE camps on any of network entity using the legacy technique.

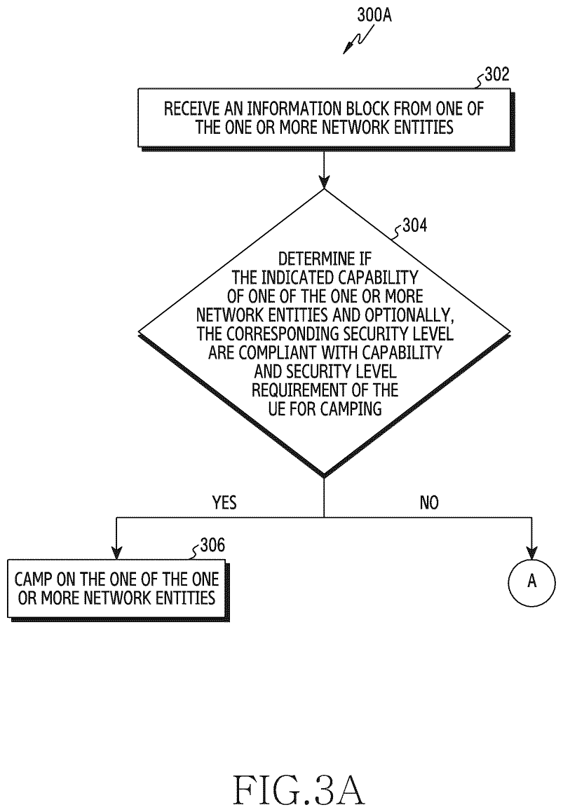

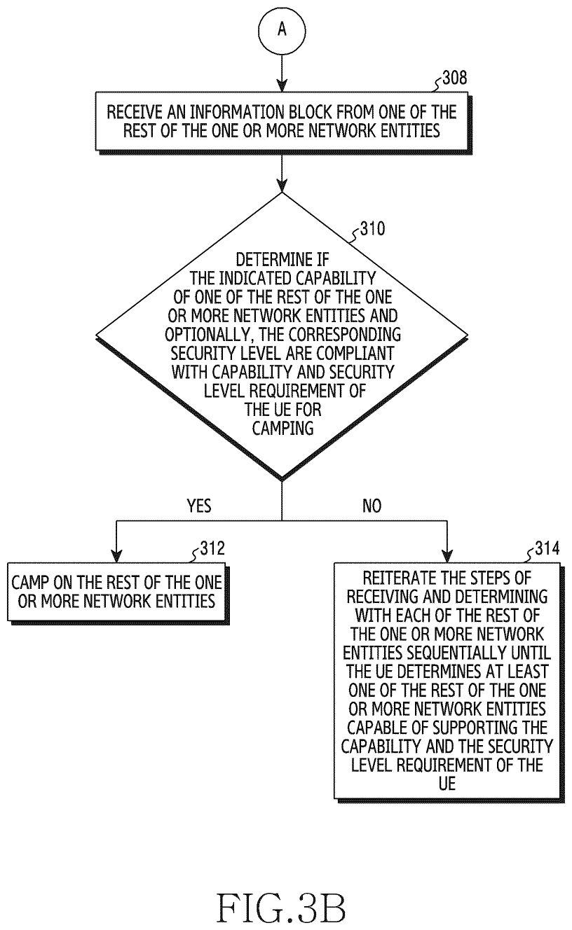

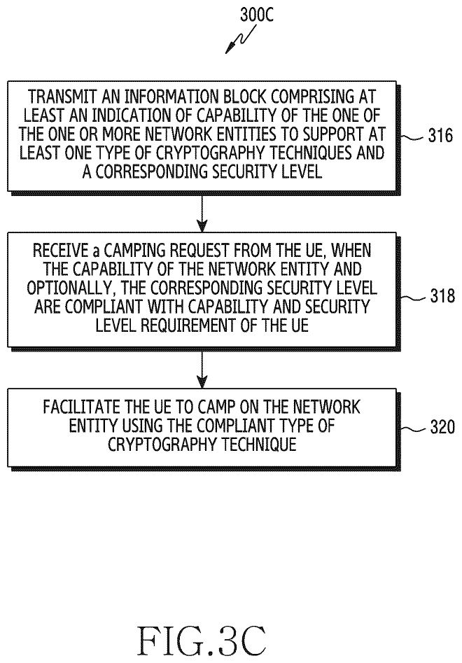

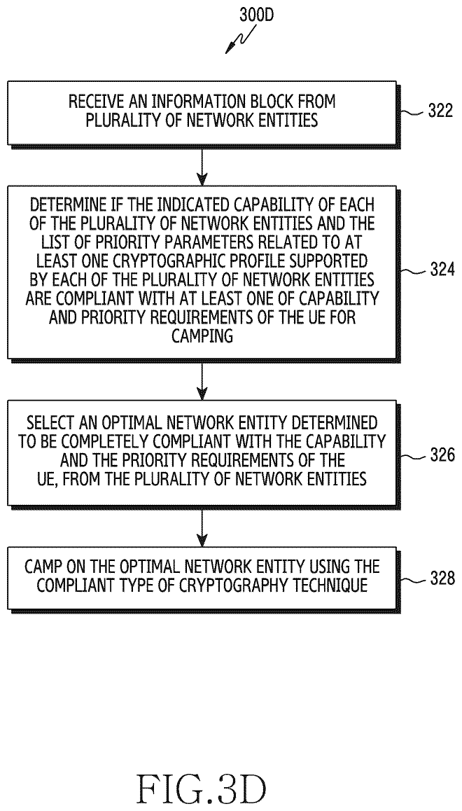

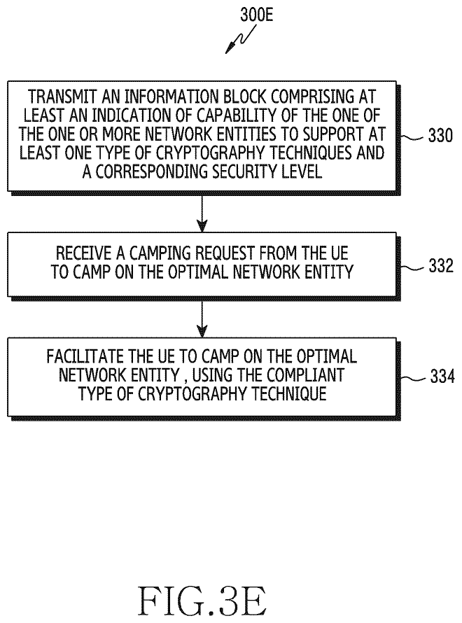

FIG. 3A illustrates a flowchart illustrating a method of a User Equipment (UE) camping on one or more network entities, according to an embodiment of the disclosure.

Referring to FIG. 3A, a method 300A includes one or more blocks illustrating the method 300A of the UE 104 camping on the one or more network entities 102. The method 300A may be described in the general context of computer executable instructions. Generally, computer executable instructions can include routines, programs, objects, components, data structures, procedures, modules, and functions, which perform functions or implement abstract data types.

The order in which the method 300A is described is not intended to be construed as a limitation, and any number of the described method blocks can be combined in any order to implement the method 300A. Additionally, individual blocks may be deleted from the methods without departing from the spirit and scope of the subject matter described herein. Furthermore, the method 300A can be implemented in any suitable hardware, software, firmware, or combination thereof.

At operation 302, the method 300A includes receiving, by the UE 104, an information block 206 from one of the one or more network entities 102 The information block 206 comprises at least an indication of capability of the network entity 102 to support at least one type of cryptography techniques and a corresponding security level. For ease of reference in the disclosure, the one of the one or more network entities 102 is depicted as network entity.

At operation 304, the method 300A includes determining, by the UE 104, if the indicated capability of the network entity 102 and optionally, the corresponding security level are compliant with capability and security level requirement of the UE 104 for camping.

If the indicated capability of the network entity 102 and optionally, the corresponding security level are compliant with capability and security level requirement of the UE 104, then the method 300A proceeds to operation 306 via “Yes”.

At operation 306, the method 300A includes camping, by the UE 104, on the one of the one or more network entities 102 using the compliant type of cryptography technique.

If the capability of the network entity 102 and optionally, the corresponding security level is determined to be not compliant with the capability and security level requirement of the UE 104, then the method 300A proceeds to operation 308 via “No” in FIG. 3B.

FIG. 3B illustrates a flowchart illustrating a method of a User Equipment (UE) camping on a network entity, according to an embodiment of the disclosure. FIG. 3B illustrates continuous operations after the operation of FIG. 3A.

Referring to FIG. 3B, at operation 308, the method 300A includes receiving, by the UE 104, an information block 206 from one of rest of the one or more network entities 102.

At operation 310, the method 300A includes determining, by the UE 104, if capability of the one of the rest of the one or more network entities 102 and optionally, corresponding security level indicated in the information block 206, are compliant with the capability and the security level requirement of the UE 104 for camping.

If capability of the one of the rest of the one or more network entities 102 and optionally, corresponding security level indicated in the information block 206, are compliant with the capability and the security level requirement of the UE 104, then the method 300A proceeds to operation 312 via “Yes”. At operation 312, the method 300A includes camping, by the UE 104, on the one of the rest of the one or more network entities 102.

If capability of the one of the rest of the one or more network entities 102 and optionally, corresponding security level indicated in the information block 206, are not compliant with the capability and the security level requirement of the UE 104, then the method 300A proceeds to operation 314 via “No”. At operation 314, the method 300A includes reiterating, by the UE 104, the steps of receiving and determining with each of the rest of the one or more network entities 102 sequentially until the UE 104 determines at least one of the rest of the one or more network entities 102 is capable of supporting the capability and the security level requirement of the UE 104, for camping.

FIG. 3C illustrates a flowchart illustrating a method of a network entity facilitating camping of a User Equipment (UE) on one or more network entities, according to an embodiment of the disclosure.

Referring to FIG. 3C, the method a includes one or more blocks illustrating a method 300C for facilitating camping of the UE 104 on one of the one or more network entities 102. The method 300C may be described in the general context of computer executable instructions. Generally, computer executable instructions can include routines, programs, objects, components, data structures, procedures, modules, and functions, which perform functions or implement abstract data types.

The order in which the method 300C is described is not intended to be construed as a limitation, and any number of the described method blocks can be combined in any order to implement the method 300C. Additionally, individual blocks may be deleted from the methods without departing from the spirit and scope of the subject matter described herein. Furthermore, the method 300C can be implemented in any suitable hardware, software, firmware, or combination thereof.

At block 316, the method 300C includes transmitting, by the network entity 102, an information block 206 comprising at least an indication of capability of the one of the one or more network entities 102 to support at least one type of cryptography techniques and a corresponding security level.

At operation 318, the method 300C includes receiving, by the network entity 102, a camping request 226 from the UE 104, when the capability of the network entity 102 and optionally, the corresponding security level are compliant with capability and security level requirement of the UE 104.

At operation 320, the method 300C includes facilitating the UE, by the network entity 102, to camp on the network entity 102 using the compliant type of cryptography technique.

FIG. 3D illustrates a flowchart illustrating a method of a User Equipment (UE) for camping on one or more network entities, according to an embodiment of the disclosure.

Referring to FIG. 3D, a method 300D includes one or more blocks illustrating a method 300D of the UE 104 for camping on one of one or more network entities 102. The method 300D may be described in the general context of computer executable instructions. Generally, computer executable instructions can include routines, programs, objects, components, data structures, procedures, modules, and functions, which perform functions or implement abstract data types.

The order in which the method 300D is described is not intended to be construed as a limitation, and any number of the described method blocks can be combined in any order to implement the method 300D. Additionally, individual blocks may be deleted from the methods without departing from the spirit and scope of the subject matter described herein. Furthermore, the method 300D can be implemented in any suitable hardware, software, firmware, or combination thereof.

At operation 322, the method 300D includes receiving, by the UE 104 an information block 224 from a plurality of network entities. The information block 224 comprises at least an indication of capability of the corresponding network entity 102 to support at least one type of cryptography technique and a list of priority parameters related to each cryptographic profile supported by the corresponding network entity 102.

At operation 324, the method 300D includes determining, by the UE 104, if the indicated capability of each of the plurality of network entities 102 and the list of priority parameters related to at least one cryptographic profile supported by each of the plurality of network entities 102 are compliant with at least one of capability and priority requirements of the UE 104 for camping.

At operation 326, the method 300D includes selecting, by the UE 104, an optimal network entity determined to be completely compliant with the capability and the priority requirements of the UE 104, from the plurality of network entities 102 whose indicated capability and the list of priority parameters related to at least one cryptographic profile supported by the network entity 102 are determined to be compliant with at least one of the capability and the priority requirements of the UE 104.

At operation 328, the method 300D includes camping, by the UE 104, on the optimal network entity, using the compliant type of cryptography technique.

In some embodiments, when the indicated capability and the list of priority parameters related to at least one cryptographic profile supported by each of the plurality of network entities 102 are determined to be not compliant with the capability and the priority requirements of the UE 104, the method 300D includes camping, by the UE 104, on any of the plurality of network entities 102 using a legacy technique.

FIG. 3E illustrates a flowchart illustrating a method of a network entity for facilitating camping of a User Equipment (UE) on one or more network entities, according to an embodiment of the disclosure.

Referring to FIG. 3E, the method 300E includes one or more blocks illustrating the method 300E for facilitating camping of the UE 104 on one of the one or more network entities 102. The method 300E may be described in the general context of computer executable instructions. Generally, computer executable instructions can include routines, programs, objects, components, data structures, procedures, modules, and functions, which perform functions or implement abstract data types.

The order in which the method 300E is described is not intended to be construed as a limitation, and any number of the described method blocks can be combined in any order to implement the method 300E. Additionally, individual blocks may be deleted from the methods without departing from the spirit and scope of the subject matter described herein. Furthermore, the method 300E can be implemented in any suitable hardware, software, firmware, or combination thereof.

At operation 330, the method 300E includes, transmitting, by plurality of network entities 102, an information block 224 including at least an indication of capability of a corresponding network entity 102 to support at least one type of cryptography techniques and a list of priority parameters related to each cryptographic profile supported by each of the plurality of network entities 102.

At operation 332, the method 300E includes, receiving, by an optimal network entity from the plurality of network entities 102, a camping request 226 from the UE 104. The indicated capability and the list of priority parameters related to at least one cryptographic profile supported by the optimal network entity are determined to be completely compliant with the capability and the priority requirements of the UE 104.

At operation 334, the method 300E includes, facilitating, by the optimal network entity, to camp on the optimal network entity, using the compliant type of cryptography technique.

In some embodiments, the method 300E further includes receiving a camping request 226 to camp on any one of the plurality of network entities 102 from the UE 104 using a legacy technique when the capability and the list of parameters related to at least one supported cryptographic profile of each of the plurality of network entities 102 are determined to be not compliant with the capability and the one or more priority requirements of the UE 104.

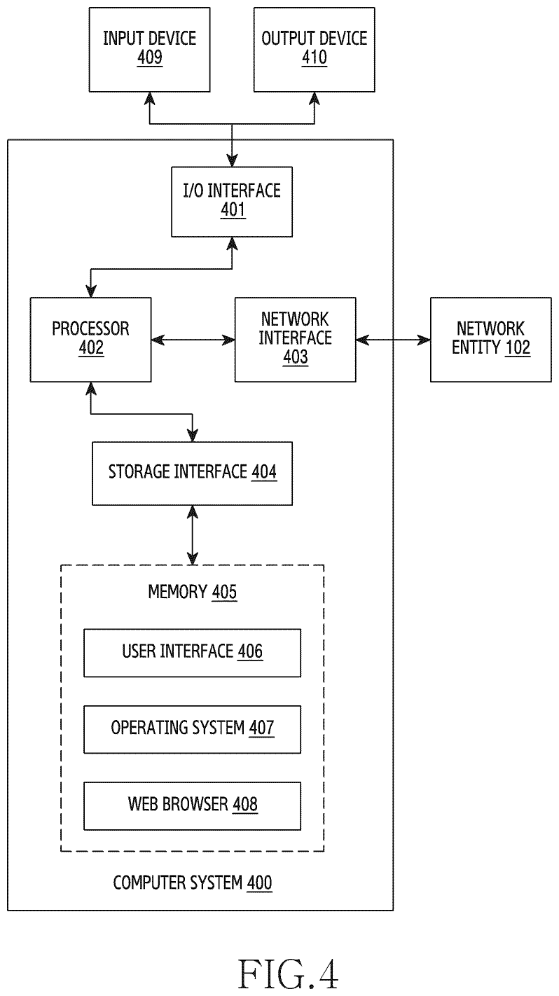

FIG. 4 illustrates a block diagram of a User Equipment (UE) according to an embodiment of the disclosure.

Referring to FIG. 4, a UE 400 may be used to receive an information block 206 from one or more network entities 102. The UE 400 may comprise a Central Processing Unit (i.e., processor 402) (also referred as “CPU” or “processor”). The processor 402 may comprise at least one data processor. The processor 402 may include specialized processing units such as integrated system (bus) controllers, memory management control units, floating point units, graphics processing units, digital signal processing units, and the like. The processor 402 may be used to realize the processor 201 described in FIGS. 2A and 2B.

The processor 402 may be disposed in communication with one or more input/output (I/O) devices (not shown) via I/O interface 401. The I/O interface 401 may employ communication protocols/methods such as, without limitation, audio, analog, digital, monoaural, RCA, stereo, IEEE (Institute of Electrical and Electronics Engineers) -1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), and the like.

Using the I/O interface 401, the UE 400 may communicate with one or more I/O devices. For example, the input device 409 is an antenna, keyboard, mouse, joystick, (infrared) remote control, camera, card reader, fax machine, dongle, biometric reader, microphone, touch screen, touchpad, trackball, stylus, scanner, storage device, transceiver, video device/source, and the like. The output device 410 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, and the like.

The processor 402 may be disposed in communication with the communication network via a network interface 403. The network interface 403 may communicate with the communication network. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, and the like. The communication network may include, without limitation, a direct interconnection, local area network (LAN), wide area network (WAN), wireless network (e.g., using Wireless Application Protocol), the Internet, and the like. The network interface 403 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, and the like.

The communication network includes, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with each other. Further, the first network and the second network may include a variety of network devices, including routers, bridges, servers, computing devices, storage devices, and the like.

In some embodiments, the processor 402 may be disposed in communication with a memory 405 (e.g., RAM, ROM, and the like not shown in FIG. 4) via a storage interface 404. The storage interface 404 may connect to memory 405 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), and the like. The memory drives may further include a drum, magnetic disc drive, magneto-optical drive, optical drive, Redundant Array of Independent Discs (RAID), solid-state memory devices, solid-state drives, and the like.

The memory 405 may store a collection of program or database components, including, without limitation, user interface 406, an operating system 407, web browser 408, and the like. In some embodiments, the UE 400 may store user/application data, such as, the data, variables, records, and the like, as described in this disclosure. Such databases may be implemented as fault-tolerant, relational, scalable, secure databases such as Oracle® or Sybase®. The memory 405 may be used to realize the memory 203 described in FIG. 4. The memory 405 may be communicatively coupled to the processor 402. The memory 405 stores instructions, executable by the one or more processors 402, which, on execution, may cause the processor 402 for operating the HARQ process of the UE 104 for receiving the NR MBS.

The operating system 407 may facilitate resource management and operation of the UE 400. Examples of operating systems include, without limitation, APPLE MACINTOSH® OS X, UNIX®, UNIX-like system distributions (E.G., BERKELEY SOFTWARE DISTRIBUTION' (BSD), FREEBSD™, NETBSD™, OPENBSD™, and the like), LINUX DISTRIBUTIONS™ (E.G., RED HAT™, UBUNTU™, KUBUNTU™, and the like), IBM™ OS/2, MICROSOFT™ WINDOWS™ (XP™, VISTA™/7/8, 10, and the like), APPLE®IOS™, GOOGLE® ANDROID™, BLACKBERRY®OS, or the like.

In some embodiments, the UE 400 may implement the web browser 408 stored program component. The web browser 408 may be a hypertext viewing application, for example MICROSOFT® INTERNET EXPLORER™, GOOGLE® CHROME™, MOZILLA® FIREFOX™, APPLE® SAFARI™, and the like. Secure web browsing may be provided using Secure Hypertext Transport Protocol (HTTPS), Secure Sockets Layer (SSL), Transport Layer Security (TLS), and the like. Web browsers 408 may utilize facilities such as AJAX™, DHTML™, ADOBE® FLASH™ JAVASCRIPT™, JAVA™, Application Programming Interfaces (APIs), and the like. In some embodiments, the UE 400 may implement a mail server (not shown in Figure) stored program component. The mail server may be an Internet mail server such as Microsoft Exchange, or the like. The mail server may utilize facilities such as ASP™ ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, and the like. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the UE 400 may implement a mail client stored program component. The mail client (not shown in Figure) may be a mail viewing application, such as APPLE® MAIL™, MICROSOFT® ENTOURAGE™, MICROSOFT® OUTLOOK™, MOZILLA® THUNDERBIRD™, and the like.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

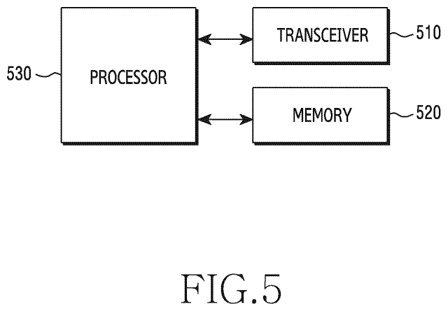

FIG. 5 illustrates a block diagram of a terminal (or a user equipment (UE)), according to an embodiment of the disclosure. FIG. 5 corresponds to the example of the UE of FIG. 2A.

Referring to FIG. 5, the UE according to an embodiment may include a transceiver 510, a memory 520, and a processor 530. The transceiver 510, the memory 520, and the processor 530 of the UE may operate according to a communication method of the UE described above. However, the components of the UE are not limited thereto. For example, the UE includes more or fewer components than those described above. In addition, the processor 530, the transceiver 510, and the memory 520 may be implemented as a single chip. Also, the processor 530 may include at least one processor.

The transceiver 510 collectively refers to a UE receiver and a UE transmitter, and may transmit/receive a signal to/from a base station or a network entity. The signal transmitted or received to or from the base station or a network entity may include control information and data. The transceiver 510 may include a RF transmitter for up-converting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

Also, the transceiver 510 may receive and output, to the processor 530, a signal through a wireless channel, and transmit a signal output from the processor 530 through the wireless channel.

The memory 520 may store a program and data required for operations of the UE. Also, the memory 520 may store control information or data included in a signal obtained by the UE. The memory 520 may be a storage medium, such as read-only memory (ROM), random access memory (RAM), a hard disk, a CD-ROM, and a DVD, or a combination of storage media.

The processor 530 may control a series of processes such that the UE operates as described above. For example, the transceiver 510 receives a data signal including a control signal transmitted by the base station or the network entity, and the processor 530 may determine a result of receiving the control signal and the data signal transmitted by the base station or the network entity.

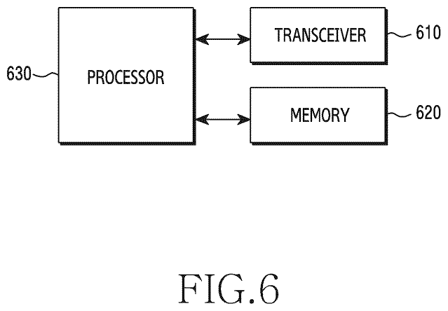

FIG. 6 illustrates a block diagram of a network entity, according to an embodiment of the disclosure. FIG. 6 corresponds to the example of the network entity of FIG. 2B.

Referring to FIG. 6, the network entity according to an embodiment may include a transceiver 610, a memory 620, and a processor 630. The transceiver 610, the memory 620, and the processor 630 of the network entity may operate according to a communication method of the network entity described above. However, the components of the network entity are not limited thereto. For example, the network entity includes more or fewer components than those described above. In addition, the processor 630, the transceiver 610, and the memory 620 may be implemented as a single chip. Also, the processor 630 may include at least one processor.

The transceiver 610 collectively refers to a network entity receiver and a network entity transmitter, and may transmit/receive a signal to/from a terminal or other network entity. The signal transmitted or received to or from the terminal or other network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the network entity. Also, the memory 620 may store control information or data included in a signal obtained by the network entity. The memory 620 may be a storage medium, such as read-only memory (ROM), random access memory (RAM), a hard disk, a CD-ROM, and a DVD, or a combination of storage media.

The processor 630 may control a series of processes such that the network entity operates as described above. For example, the transceiver 610 receives a data signal including a control signal transmitted by the terminal, and the processor 630 may determine a result of receiving the control signal and the data signal transmitted by the terminal.

Accordingly, the embodiment herein is to provide a method of user equipment (UE) for camping on a network entity, the method comprising: receiving, by a UE, an information block from one of one or more network entities, wherein the information block comprises at least an indication of capability of the network entity to support at least one type of cryptography techniques and a corresponding security level, determining, by the UE, based on the indicated capability of the network entity and optionally, the corresponding security level being compliant with capability and security level requirement of the UE for camping; and camping, by the UE, on the network entity when the indicated capability and optionally, the corresponding security level supported by the network entity is determined to be compliant with the capability and the security level requirement of the UE using the compliant type of cryptography technique.

In an embodiment, by the UE, based on the capability of the network entity and optionally, the corresponding security level being determined to be not compliant with the capability and security level requirement of the UE, the method further comprises: receiving, by the UE, an information block from one of rest of one or more network entities; determining, by the UE, whether capability of the one of the rest of the one or more network entities and optionally, corresponding security level indicated in the information block, are compliant with the capability and the security level requirement of the UE for camping; camping, by the UE, on the one of the rest of the one or more network entities when the indicated capability and optionally, the corresponding security level supported by the one of the rest of the one or more network entities is determined to be compliant with the capability and the security level requirement of the UE using the compliant type of cryptography technique; reiterating, by the UE, when the capability of the one of rest of the one or more network entities and optionally, the corresponding security level is determined to be not compliant or partially compliant with the capability and the security level requirement of the UE, and wherein the steps of receiving and determining with each of the rest of the one or more network entities sequentially until the UE determines at least one of the rest of the one or more network entities capable of supporting the capability and the security level requirement of the UE, for camping.

In an embodiment, by the UE, when the one or more network entities are determined to be non-compliant with the capability and the security level requirement of the UE, camping, by the UE, on one of the one or more network entities using a legacy technique.

In an embodiment, by the UE, the type of cryptography techniques comprises at least one of a post quantum cryptography (PQC) technique, Quantum technique, a symmetric cryptography technique or an asymmetric cryptography technique.

In an embodiment, by the UE, the capability of the network entity to support at least one type of cryptography techniques is indicated in the information block by providing at least one of: an information indicating name(s) of cryptography techniques supported by the network entity, a list of cryptography profiles supported by the network entity, or a list of frequencies related to each cryptography profile supported by the network entity.

In an embodiment, by the UE, the information block is one of a system information block (SIB), a master information block (MIB), a radio resource configuration (RRC) release message or an RRC rejection message.

In an embodiment, by the UE, the capability of the UE indicates one or more types of cryptographic techniques that the UE is capable of supporting for the camping, and the security level requirement of the UE indicates a minimum security level that the UE is expected to maintain while using a type of cryptographic technique for the camping.

In an embodiment, by the UE, the information block is received from the one or more network entities in response to a capability request from the UE.

In an embodiment, the information block is received from the one or more network entities in a form of a broadcast signal.

In an embodiment, by the UE, prior to camping, the method comprises selecting, by the UE, a network entity for camping from the one or more network entities determined to be capable of supporting the capability and the security level requirement of the UE, randomly or based on one or more priorities of the UE, and wherein the one or more priorities are related to the type of cryptography technique, a cryptography profile, and optionally, the corresponding security level.

In an embodiment, by the UE, the method further includes barring for a predetermined time duration, by the UE, one or more network entities that are determined to be non-compliant with the capability and the security level requirement of the UE.

Accordingly, the embodiment herein is to provide a method of a network entity for facilitating camping of a user equipment (UE) on the network entity, the method comprises: transmitting, by the network entity, an information block comprising at least an indication of capability of the network entity to support at least one type of cryptography techniques and a corresponding security level; receiving, by the network entity, a camping request from the UE, when the capability of the network entity and optionally, the corresponding security level are compliant with capability and security level requirement of the UE; and facilitating, by the network entity, the UE to camp on the network entity using the compliant type of cryptography technique, based on the UE determining the network entity to be capable of supporting the capability and optionally, the security level requirement of the UE.

In an embodiment, by the network entity, the information block is transmitted in response to a capability request from the UE.

In an embodiment, by the network entity, the information block is transmitted in a form of a broadcast signal to the UE.

In an embodiment, by the network entity, based on the capability of the network entity and optionally, the corresponding security level being determined to be not compliant with the capability and the security level requirement of the UE, the method further comprises: receiving, by one of rest of one or more network entities, a camping request from the UE, when the UE determines the capability of the one of the rest of the one or more network entities and optionally, the corresponding security level to be compliant with capability and the security level requirement of the UE.

In an embodiment, by the network entity, the camping request comprises an identifier of the UE encoded using the compliant type of cryptography technique.

In an embodiment, by the network entity, facilitating the UE to camp comprises: decoding, by the network entity, the identifier of the UE using the compliant type of cryptography technique; and facilitating, by the network entity, the UE to camp on the network entity upon decoding the identifier successfully.

Accordingly, the embodiment herein is to provide a User Equipment (UE) for camping on a network entity. The UE includes at least one processor; and memory communicatively coupled to the at least one processor, wherein the memory stores instructions being executed, cause the at least one processor to: receive an information block from one of one or more network entities, wherein the information block comprises at least an indication of capability of the network entity to support at least one type of cryptography techniques and a corresponding security level, determine whether the indicated capability of the network entity and optionally, the corresponding security level are compliant with capability and security level requirement of the UE for camping, and camp on the network entity when the indicated capability and optionally, the corresponding security level supported by the network entity is determined to be compliant with the capability and the security level requirement of the UE using the compliant type of cryptography technique.

In an embodiment, by the UE, based on the capability of the network entity and optionally, the corresponding security level being determined to be not compliant with the capability and security level requirement of the UE, the instructions executed by the at least one processor further cause the UE to: receive an information block from one of rest of the one or more network entities; determine whether capability of the one of the rest of the one or more network entities and optionally, corresponding security level indicated in the information block, are compliant with the capability and the security level requirement of the UE for camping; camp on the one of the rest of the one or more network entities when the indicated capability and optionally, the corresponding security level supported by the one of the rest of the one or more network entities is determined to be compliant with the capability and the security level requirement of the UE using the compliant type of cryptography technique; and reiterate when the capability of the one of rest of the one or more network entities and optionally, the corresponding security level is determined to be not compliant or partially compliant with the capability and the security level requirement of the UE, and wherein the steps of receiving and determining with each of the rest of the one or more network entities sequentially until the UE determines at least one of the rest of the one or more network entities capable of supporting the capability and the security level requirement of the UE, for camping.

In an embodiment, by the UE, the capability of the network entity to support at least one type of cryptography techniques is indicated in the information block by providing at least one of: an information indicating name(s) of cryptography techniques supported by the network entity, a list of cryptography profiles supported by the network entity, or a list of frequencies related to each cryptography profile supported by the network entity.

In an embodiment, by the UE, prior to camping, the instruction executed by the at least one processor further cause the UE to select a network entity for camping from the one or more network entities determined to be capable of supporting the capability and the security level requirement of the UE, randomly or based on one or more priorities of the UE, and the one or more priorities are related to the type of cryptography technique, a cryptography profile, and optionally, the corresponding security level.

In an embodiment, by the UE, the at least one processor is further configured to bar for a predetermined time duration, one or more network entities that are determined to be non-compliant with the capability and the security level requirement of the UE.

Accordingly, the embodiment herein is to provide a network entity for facilitating camping of a user equipment (UE) on the network entity. The network entity includes at least one processor; and memory communicatively coupled to the at least one processor, wherein the memory stores instructions, which executed by the at least one processor cause the network entity to: transmit an information block comprising at least an indication of capability of the network entity to support at least one type of cryptography techniques and a corresponding security level, receive a camping request from the UE, when the capability of the network entity and optionally, the corresponding security level are compliant with capability and security level requirement of the UE, and facilitate the UE to camp on the network entity using the compliant type of cryptography technique, based on the UE determining the network entity to be capable of supporting the capability and optionally, the security level requirement of the UE.

In an embodiment, by the network entity, based on the capability of the network entity and optionally, the corresponding security level being determined to be not compliant with the capability and the security level requirement of the UE, the instructions executed by the at least one processor further cause the network entity to: receive a camping request from the UE when the UE determines the capability of one of rest of one or more network entities and optionally, the corresponding security level to be compliant with capability and the security level requirement of the UE.

In an embodiment, by the network entity, to facilitate the UE to camp on, the instruction executed by the at least one processor cause the network entity to: decode an identifier of the UE using the compliant type of cryptography technique; and facilitate the UE to camp on the network entity upon decoding the identifier successfully.

Accordingly, the embodiment herein is to provide a method of user equipment (UE) for camping on a network entity, the method comprising: receiving, by a UE, an information block from a plurality of network entities, wherein the information block comprises at least an indication of capability of the corresponding network entity to support at least one type of cryptography technique and a list of priority parameters related to each cryptographic profile supported by the corresponding network entity; determining, by the UE, whether the indicated capability of each of the plurality of network entities and the list of priority parameters related to at least one cryptographic profile supported by each of the plurality of network entities are compliant with at least one of capability and priority requirements of the UE for camping; selecting, by the UE, an optimal network entity determined to be completely compliant with the capability and the priority requirements of the UE, from the plurality of network entities whose indicated capability and the list of priority parameters related to at least one cryptographic profile supported by the network entity are determined to be compliant with at least one of the capability and the priority requirements of the UE; and camping, by the UE, on the optimal network entity, using the compliant type of cryptography technique.

In an embodiment, by the UE, when the indicated capability and the list of priority parameters related to at least one cryptographic profile supported by each of the plurality of network entities are determined to be not compliant with the capability and the priority requirements of the UE, camping, by the UE, on any of the plurality of network entities using a legacy technique.

In an embodiment, by the UE, the list of priority parameters are related to prioritizing at least one of a type of cryptography technique, a cryptographic profile, corresponding key length and corresponding security level.

Accordingly, the embodiment herein is to provide a method of network entity for facilitating camping of a user equipment (UE) on the network entity, the method comprises: transmitting, by a plurality of network entities, an information block comprising at least an indication of capability of a corresponding network entity to support at least one type of cryptography techniques and a list of priority parameters related to each cryptographic profile supported by each of the plurality of network entities; receiving, by an optimal network entity from the plurality of network entities, a camping request from the UE, wherein the indicated capability and the list of priority parameters related to at least one cryptographic profile supported by the optimal network entity are determined to be completely compliant with the capability and priority requirements of the UE; and facilitating, by the optimal network entity, the UE to camp on the optimal network entity, using the compliant type of cryptography technique.

In an embodiment, by the UE, when indicated capability and the list of priority parameters related to at least one cryptographic profile supported by each of the plurality of network entities are determined to be not compliant with the capability and the priority requirements of the UE, receiving, by any one of the plurality of network entities, a camping request from the UE, to camp using a legacy technique.

Accordingly, the embodiment herein is to provide a user equipment (UE) for camping on a network entity. The UE includes at least one processor; and memory communicatively coupled to the at least one processor, wherein the memory stores instructions, which executed by the at least one processor , cause the UE to: receive an information block from a plurality of network entities, wherein the information block comprises at least an indication of capability of the corresponding network entity to support at least one type of cryptography technique and a list of priority parameters related to each cryptographic profile supported by the corresponding network entity, determine whether the indicated capability of each of the plurality of network entities and the list of priority parameters related to at least one cryptographic profile supported by each of the plurality of network entities are compliant with at least one of capability and priority requirements of the UE for camping, select an optimal network entity determined to be completely compliant with the capability and the priority requirements of the UE, from the plurality of network entities whose indicated capability and the list of priority parameters related to at least one cryptographic profile supported by the network entity are determined to be compliant with at least one of the capability and the priority requirements of the UE, and camp on the optimal network entity, using the compliant type of cryptography technique.

In an embodiment, by the UE, when the indicated capability and the list of priority parameters related to at least one cryptographic profile supported by each of the plurality of network entities are determined to be not compliant with the capability and the priority requirements of the UE, the at least one processor enables camping on any of the plurality of network entities using a legacy technique.

In an embodiment, by the UE, the list of priority parameters are related to prioritizing at least one of a type of cryptography technique, a cryptographic profile, corresponding key length and corresponding security level.

Accordingly, the embodiment herein is to provide a network entity for facilitating camping of a user equipment (UE) on the network entity, the network entity comprises: at least one processor; and memory communicatively coupled to the at least one processor, wherein the memory stores instructions, which executed by the at least one processor cause the network entity to: transmit an information block comprising at least an indication of capability of a corresponding network entity to support at least one type of cryptography techniques and a list of priority parameters related to each cryptographic profile supported by each of a plurality of network entities, receive a camping request from the UE, wherein the indicated capability and the list of priority parameters related to at least one cryptographic profile supported by an optimal network entity are determined to be completely compliant with the capability and priority requirements of the UE, and facilitate the UE to camp on the optimal network entity, using the compliant type of cryptography technique.

In an embodiment, by the network entity, when indicated capability and the list of priority parameters related to at least one cryptographic profile supported by each of the plurality of network entities are determined to be not compliant with the capability and the priority requirements of the UE, the instructions executed by the at least one processor, is further cause the network entity to: receive a camping request from the UE, to camp using a legacy technique.

Accordingly, the embodiment herein is to provide a non-transitory computer readable storage with instructions stored thereon, the instructions being executed by at least one processor to perform a method of user equipment (UE) for camping on a network entity, the method comprising: receiving, by a UE, an information block from one of one or more network entities, wherein the information block comprises at least an indication of capability of the network entity to support at least one type of cryptography techniques and a corresponding security level; determining, by the UE, whether the indicated capability of the network entity and optionally, the corresponding security level are compliant with capability and security level requirement of the UE for camping; and camping, by the UE, on the network entity when the indicated capability and optionally, the corresponding security level supported by the network entity is determined to be compliant with the capability and the security level requirement of the UE using the compliant type of cryptography technique.

In an embodiment, by the non-transitory computer readable storage, when no network entity has the indicated capability are compliant with capability and security level requirement of the UE for camping, camp on any network entity.

In an embodiment, by the non-transitory computer readable storage, the information block is a master information block (MIB).

In the afore-described embodiments of the disclosure, elements included in the disclosure are expressed in a singular or plural form according to the embodiments. However, the singular or plural form is appropriately selected for convenience of explanation and the disclosure is not limited thereto. As such, an element expressed in a plural form may also be configured as a single element, and an element expressed in a singular form may also be configured as plural elements.

The disclosure may provide an optimized approach for camping on one or more network entities by a UE because of determination of compliance of capability of the UE and the one or more network entities, rejections from the one or more network entities may be avoided resulting in no delay in camping and registration process. Further, because of the optimized approach, the disclosure enables the UE to be camped on a highly secured network entity, thereby, preventing quantum attacks.

In light of the technical advancements provided by the disclosed method and the control module, the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure (s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the disclosure.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of disclosure need not include the device itself.

Finally, the language used in the specification has been principally selected for readability and instructional purposes, and it may not have been selected to delineate or circumscribe the inventive subject matter. It is, therefore, intended that the scope of the disclosure be limited not by this detailed description, but rather by any claims that issue on an application based here on. Accordingly, the embodiments of the disclosure are intended to be illustrative, but not limiting, of the scope of the disclosure, which is set forth in the following claims.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) for camping on a network entity in a wireless communication system, the method comprising:
receiving, from the network entity, an information block from one of one or more network entities, wherein the information block comprises at least an indication of capability of the network entity to support at least one type of cryptography techniques and a corresponding security level;
determining, based on the indicated capability of the network entity or the corresponding security level being compliant with capability and security level requirement of the UE for camping; and
camping on the network entity when the indicated capability or the corresponding security level supported by the network entity is determined to be compliant with the capability and the security level requirement of the UE using the compliant type of cryptography technique.

2. The method of claim 1, wherein, based on the capability of the network entity or the corresponding security level being determined to be not compliant with the capability and security level requirement of the UE, the method further comprises:
receiving, by the UE, an information block from one of rest of one or more network entities;
determining whether capability of the one of the rest of the one or more network entities or corresponding security level indicated in the information block, are compliant with the capability and the security level requirement of the UE for camping;
camping on the one of the rest of the one or more network entities when the indicated capability or the corresponding security level supported by the one of the rest of the one or more network entities is determined to be compliant with the capability and the security level requirement of the UE using the compliant type of cryptography technique; and
reiterating when the capability of the one of rest of the one or more network entities or the corresponding security level is determined to be not compliant or partially compliant with the capability and the security level requirement of the UE, and
wherein the steps of receiving and determining with each of the rest of the one or more network entities sequentially until the UE determines at least one of the rest of the one or more network entities capable of supporting the capability and the security level requirement of the UE, for camping.

3. The method of claim 1,
wherein, when the one or more network entities are determined to be non-compliant with the capability and the security level requirement of the UE, camping, by the UE, on one of the one or more network entities using a legacy technique,
wherein the type of cryptography techniques comprises at least one of a post quantum cryptography (PQC) technique, Quantum technique, a symmetric cryptography technique or an asymmetric cryptography technique, and
wherein the capability of the network entity to support at least one type of cryptography techniques is indicated in the information block by providing at least one of:
an information indicating name(s) of cryptography techniques supported by the network entity,
a list of cryptography profiles supported by the network entity, or
a list of frequencies related to each cryptography profile supported by the network entity.

4. The method of claim 1, wherein the information block is one of a system information block (SIB), a master information block (MIB), a radio resource configuration (RRC) release message or an RRC rejection message.

5. The method of claim 1,
wherein the capability of the UE indicates one or more types of cryptographic techniques that the UE is capable of supporting for the camping, and
wherein the security level requirement of the UE indicates a minimum security level that the UE is expected to maintain while using a type of cryptographic technique for the camping.

6. The method of claim 1, wherein the information block is received from the one or more network entities in response to a capability request from the UE or the one or more network entities in a form of a broadcast signal.

7. The method of claim 1,
wherein, prior to camping, the method comprises selecting a network entity for camping from the one or more network entities determined to be capable of supporting the capability and the security level requirement of the UE, randomly or based on one or more priorities of the UE, and
wherein the one or more priorities are related to the type of cryptography technique, a cryptography profile or the corresponding security level.

8. The method of claim 1, further comprises barring for a predetermined time duration, by the UE, one or more network entities that are determined to be non-compliant with the capability and the security level requirement of the UE.

9. A method performed by a network entity for facilitating camping of a user equipment (UE) in a wireless communication system, the method comprises:
transmitting, to the UE, an information block comprising at least an indication of capability of the network entity to support at least one type of cryptography techniques and a corresponding security level;
receiving a camping request from the UE, when the capability of the network entity or the corresponding security level are compliant with capability and security level requirement of the UE; and
facilitating the UE to camp on the network entity using the compliant type of cryptography technique, based on the UE determining the network entity to be capable of supporting the capability or the security level requirement of the UE.

10. The method of claim 9, wherein the information block is transmitted in response to a capability request from the UE.

11. The method of claim 9, wherein the information block is transmitted in a form of a broadcast signal to the UE.

12. The method of claim 9, wherein, based on the capability of the network entity or the corresponding security level being determined to be not compliant with the capability and the security level requirement of the UE, the method further comprises:
receiving, by one of rest of one or more network entities, a camping request from the UE, when the UE determines the capability of the one of the rest of the one or more network entities or the corresponding security level to be compliant with capability and the security level requirement of the UE.

13. The method of claim 9, wherein the camping request comprises an identifier of the UE encoded using the compliant type of cryptography technique.

14. The method of claim 13, wherein facilitating the UE to camp comprises:
decoding, by the network entity, the identifier of the UE using the compliant type of cryptography technique; and
facilitating, by the network entity, the UE to camp on the network entity upon decoding the identifier successfully.

15. A User Equipment (UE) for camping on a network entity in a wireless communication system, the UE comprising:
a memory; and
at least one processor coupled with the memory, wherein the at least one processor is configured to:
receive an information block from one of one or more network entities, wherein the information block comprises at least an indication of capability of the network entity to support at least one type of cryptography techniques and a corresponding security level,
determine whether the indicated capability of the network entity, and the corresponding security level are compliant with capability and security level requirement of the UE for camping, and
camp on the network entity when the indicated capability, and the corresponding security level supported by the network entity is determined to be compliant with the capability and the security level requirement of the UE using the compliant type of cryptography technique.

16. The UE of claim 15, wherein, based on the capability of the network entity or the corresponding security level being determined to be not compliant with the capability and security level requirement of the UE, the instructions executed by the at least one processor further cause the UE to:
receive an information block from one of rest of the one or more network entities;
determine whether capability of the one of the rest of the one or more network entities or corresponding security level indicated in the information block, are compliant with the capability and the security level requirement of the UE for camping;
camp on the one of the rest of the one or more network entities when the indicated capability or the corresponding security level supported by the one of the rest of the one or more network entities is determined to be compliant with the capability and the security level requirement of the UE using the compliant type of cryptography technique; and
reiterate when the capability of the one of rest of the one or more network entities or the corresponding security level is determined to be not compliant or partially compliant with the capability and the security level requirement of the UE, and
wherein the steps of receiving and determining with each of the rest of the one or more network entities sequentially until the UE determines at least one of the rest of the one or more network entities capable of supporting the capability and the security level requirement of the UE, for camping.

17. A network entity for facilitating camping of a user equipment (UE) in a wireless communication system, the network entity comprises:
a memory; and
at least one processor coupled with the memory, wherein the at least one processor, wherein the memory stores instructions, which the at least one processor is configured to:
transmit an information block comprising at least an indication of capability of the network entity to support at least one type of cryptography techniques and a corresponding security level,
receive a camping request from the UE, when the capability of the network entity or the corresponding security level are compliant with capability and security level requirement of the UE, and
facilitate the UE to camp on the network entity using the compliant type of cryptography technique, based on the UE determining the network entity to be capable of supporting the capability or the security level requirement of the UE.

18. A method performed by a user equipment (UE) for camping on a network entity in a wireless communication system, the method comprising:
receiving, from the network entity, an information block from a plurality of network entities, wherein the information block comprises at least an indication of capability of the corresponding network entity to support at least one type of cryptography technique and a list of priority parameters related to each cryptographic profile supported by the corresponding network entity;
determining whether the indicated capability of each of the plurality of network entities and the list of priority parameters related to at least one cryptographic profile supported by each of the plurality of network entities are compliant with at least one of capability and priority requirements of the UE for camping;
selecting an optimal network entity determined to be completely compliant with the capability and the priority requirements of the UE, from the plurality of network entities whose indicated capability and the list of priority parameters related to at least one cryptographic profile supported by the network entity are determined to be compliant with at least one of the capability and the priority requirements of the UE; and
camping on the optimal network entity, using the compliant type of cryptography technique.

19. The method of claim 18, wherein when the indicated capability and the list of priority parameters related to at least one cryptographic profile supported by each of the plurality of network entities are determined to be not compliant with the capability and the priority requirements of the UE, camping on any of the plurality of network entities using a legacy technique.

20. The method of claim 18, wherein the list of priority parameters are related to prioritizing at least one of a type of cryptography technique, a cryptographic profile, corresponding key length and corresponding security level.
